(19) United States
(12) Patent Application Publication
(10) Pub. No.: US 2015/0369966 A1
(43) Pub. Date: Dec. 24, 2015

(54) ANTI-REFLECTION FILM AND PRODUCTION METHOD THEREFOR

(71) Applicant: NITTO DENKO CORPORATION, Ibaraki-shi, Osaka (JP)

(72) Inventors: Atsushi Kishi, Ibaraki-shi (JP); Tomonori Ueno, Ibaraki-shi (JP); Hiroki Kuramoto, Ibaraki-shi (JP)

(73) Assignee: NITTO DENKO CORPORATION, Ibaraki-shi, Osaka (JP)

(21) Appl. No.: 14/763,583

(22) PCT Filed: Jan. 27, 2014
(86) PCT No.: PCT/JP2014/051657

§ 371 Date: Jul. 27, 2015

(30) Foreign Application Priority Data
Jan. 29, 2013 (JP) 2013-014457
Jan. 24, 2014 (JP) 2014-011690

(51) Int. Cl. G02B 1/11; G02B 5/30

(52) U.S. Cl. CPC G02B 1/11; G02B 5/30

(57) ABSTRACT

An anti-reflection film according to the present invention includes: a substrate; and a medium-refractive index layer, a high-refractive index layer, and a low-refractive index layer in the stated order from a substrate side. When optical design of a reflection characteristic of the anti-reflection film is performed with a complex plane of a reflectance amplitude diagram at a wavelength of 580 nm, refractive indices and/or thicknesses of the substrate, the medium-refractive index layer, the high-refractive index layer, and the low-refractive index layer are designed in such a manner that a line AB connecting a starting point A and an ending point B of a lamination locus of the high-refractive index layer intersects a real axis of the reflectance amplitude diagram.

### TECHNICAL FIELD

The present invention relates to an anti-reflection film and a method of producing the film. More specifically, the present invention relates to a method of producing an anti-reflection film including a dry process and a wet process, and an anti-reflection film to be obtained by the production method.

### BACKGROUND ART

An anti-reflection film to be placed on the surface of the display screen of, for example, a CRT, a liquid crystal display apparatus, or a plasma display panel has heretofore been widely used for preventing the reflection of ambient light on the display screen. As the anti-reflection film, there has been known, for example, a multilayer film having a layer formed of a medium-refractive index material, a layer formed of a high-refractive index material, and a layer formed of a low-refractive index material. It has been known that the use of such multilayer film can provide high anti-reflection performance (a low reflectance in a wide spectrum). The anti-reflection performance of the anti-reflection film is generally evaluated in terms of a luminous reflectance Y (%), and as the luminous reflectance reduces, the anti-reflection performance becomes more excellent. However, when an attempt is made to reduce the luminous reflectance, there arises a problem in that a reflection hue is liable to be colored. In particular, even when the coloring of the reflection hue of incident light in a front direction can be suppressed, the reflection hue of incident light in an oblique direction colors in many cases.

### CITATION LIST

### Patent Literature

[PTL 1] JP 11-204065 A

[PTL 2] JP 5249054 B2

### SUMMARY OF INVENTION

### Technical Problem

The present invention has been made to solve the conventional problems, and an object of the present invention is to provide an anti-reflection film, which has an excellent reflection characteristic (low reflectivity) in a wide spectrum and prevents the coloring of the reflection hue of incident light not only from a front direction but also from an oblique direction.

### Solution to Problem

An anti-reflection film according to the present invention includes: a substrate; and a medium-refractive index layer, a high-refractive index layer, and a low-refractive index layer in the stated order from a substrate side. When optical design of a reflection characteristic of the anti-reflection film is performed with a complex plane of a reflectance amplitude diagram at a wavelength of 580 nm, refractive indices and/or thicknesses of the substrate, the medium-refractive index layer, the high-refractive index layer, and the low-refractive index layer are designed in such a manner that a line AB connecting a starting point A and an ending point B of a lamination locus of the high-refractive index layer intersects a real axis of the reflectance amplitude diagram.

In one embodiment of the present invention, the refractive indices and/or thicknesses of the substrate, the medium-refractive index layer, the high-refractive index layer, and the low-refractive index layer are designed in such a manner that the line AB and the real axis intersect each other, and an angle θ formed between the line AB and the real axis satisfies a relationship of 65° 090°.

In one embodiment of the present invention, when the optical design of the reflection characteristic of the anti-reflection film is performed with the complex plane of the reflectance amplitude diagram, the refractive indices and/or thicknesses of the substrate, the medium-refractive index layer, the high-refractive index layer, and the low-refractive index layer are designed in such a manner that the line AB and the real axis intersect each other in each of optical designs over a wavelength range of from 550 nm to 700 nm.

In one embodiment of the present invention, the medium-refractive index layer is a single layer.

In one embodiment of the present invention, the thickness of the high-refractive index layer is 50 nm or less.

In one embodiment of the present invention, the medium-refractive index layer has a laminated structure of another high-refractive index layer and another low-refractive index layer arranged in the stated order from the substrate side.

According to another aspect of the present invention, there is provided a polarizing plate with an anti-reflection film. The polarizing plate with an anti-reflection film includes the anti-reflection film as described above.

According to still another aspect of the present invention, there is provided an image display apparatus. The image display apparatus includes the anti-reflection film as described above or the polarizing plate with an anti-reflection film as described above.

### Advantageous Effects of Invention

According to the one embodiment of the present invention, when the optical design of a reflection characteristic of an anti-reflection film is performed with the complex plane of a reflectance amplitude diagram at a wavelength of 580 nm, the refractive indices and/or thicknesses of its respective layers are designed in such a manner that a line AB connecting a starting point A and an ending point B of the lamination locus of a high-refractive index layer intersects the real axis of the reflectance amplitude diagram. Thus, the anti-reflection film, which has an excellent reflection characteristic (low reflectivity) in a wide spectrum and prevents the coloring of the reflection hue of incident light not only from a front direction but also from an oblique direction, can be realized. Further, such optical design is comprehensive, and hence eliminates the need to investigate the thicknesses and/or refractive indices of the respective layers of each product through trial and error. Accordingly, the optimization of the reflection characteristic and the reflection hue can be performed in an extremely general and easy manner.

### BRIEF DESCRIPTION OF DRAWINGS

FIG. 1A is a schematic sectional view of an anti-reflection film according to one embodiment of the present invention.

FIG. 1B is a schematic sectional view of an anti-reflection film according to another embodiment of the present invention.

FIG. 2A is a reflectance amplitude diagram for illustrating the concept of one optical design of a wide-spectrum anti-reflection film (medium-refractive index layer/high-refractive index layer/low-refractive index layer).

FIG. 2B is a reflectance amplitude diagram for illustrating the concept of another optical design of a wide-spectrum anti-reflection film (medium-refractive index layer/high-refractive index layer/low-refractive index layer).

FIG. 3 is a view for illustrating a relationship between an optical design in which an intersection angle θ between a line AB and a real axis in a reflectance amplitude diagram is changed, and a reflection hue for incident light from an oblique direction actually obtained by the design through comparison.

FIG. 4 is a view for illustrating a relationship between an optical design in which an intersection angle θ between a line AB and a real axis in a reflectance amplitude diagram is changed, and a reflection hue for incident light from an oblique direction actually obtained by the design through comparison.

FIG. 5 is a view for illustrating a relationship between an optical design in which an intersection angle θ between a line AB and a real axis in a reflectance amplitude diagram is changed, and a reflection hue for incident light from an oblique direction actually obtained by the design through comparison.

FIG. 6 is a view for illustrating a change in relationship between the line AB and the real axis in the case where a design wavelength is changed for each of two optical designs using reflectance amplitude diagrams through comparison.

### DESCRIPTION OF EMBODIMENTS

Hereinafter, preferred embodiments of the present invention are described with reference to the drawings, but the present invention is not limited to these embodiments. It should be noted that the lengths, thicknesses, and the like of the respective layers and the like in the drawings are different from actual scales for ease of viewing.

A. Entire Construction of Anti-Reflection Film

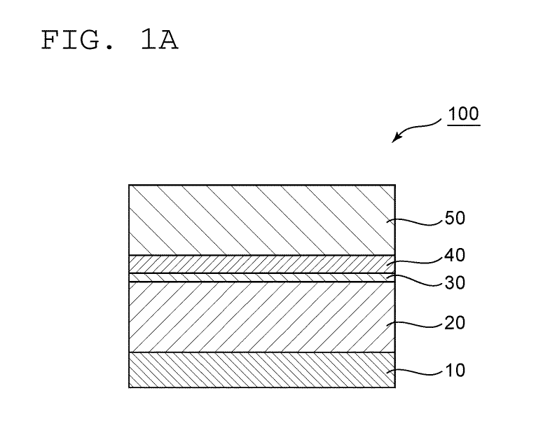

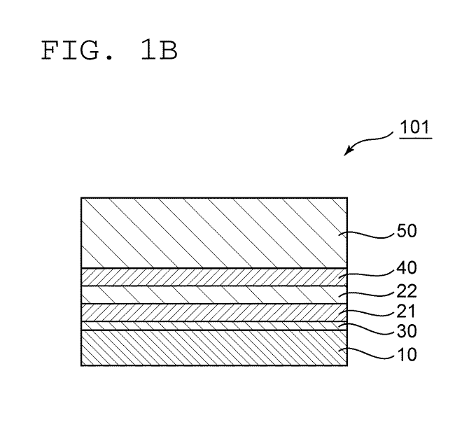

FIG. 1A is a schematic sectional view of an anti-reflection film according to one embodiment of the present invention. An anti-reflection film 100 includes a substrate 10, and a medium-refractive index layer 20, an adhesion layer 30 to be arranged as required, a high-refractive index layer 40, and a low-refractive index layer 50 in the stated order from the substrate 10 side. In this embodiment, the medium-refractive index layer 20 is a single layer. FIG. 1B is a schematic sectional view of an anti-reflection film according to another embodiment of the present invention. In this embodiment, the medium-refractive index layer 20 is replaced with a laminated structure optically equivalent to the single layer illustrated in FIG. 1A. Specifically, an anti-reflection film 101 includes the substrate 10, and another high-refractive index layer 21, another low-refractive index layer 22, the high-refractive index layer 40, and the low-refractive index layer 50 in the stated order from the substrate 10 side. In this description, the laminated structure of the other high-refractive index layer 21 and the other low-refractive index layer 22 is sometimes referred to as “medium-refractive index layer” for convenience. In this embodiment, the adhesion layer 30 may be arranged between the substrate 10 and the other high-refractive index layer 21 as required. It should be noted that in each of the embodiments of FIG. 1A and FIG. 1B, the position at which the adhesion layer 30 is arranged is not limited as long as the layer does not impair the optical characteristics of the entirety of the anti-reflection film and improves adhesiveness between adjacent layers. Details about the respective layers constituting the anti-reflection film of the present invention are described later.

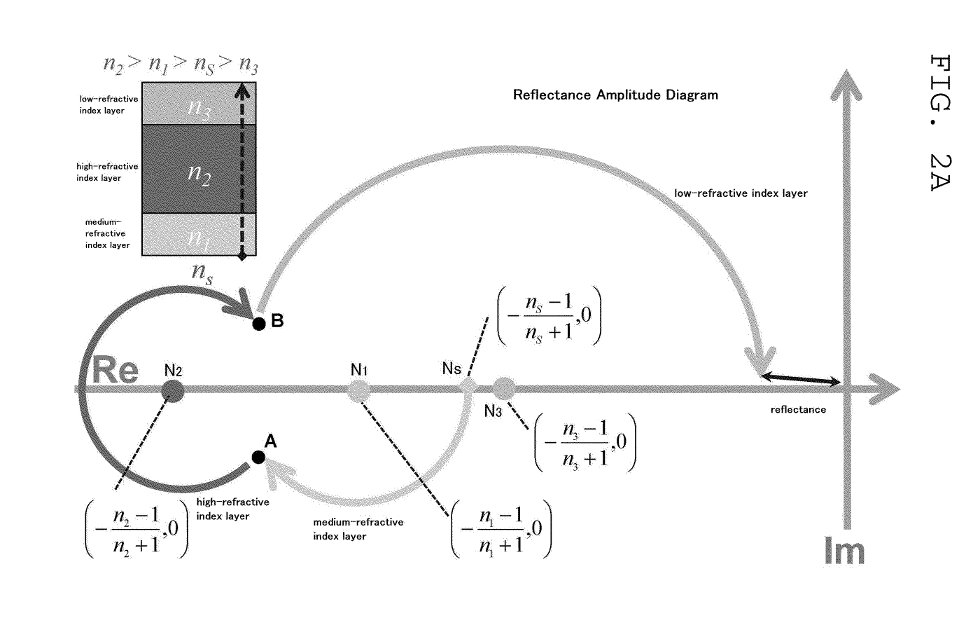

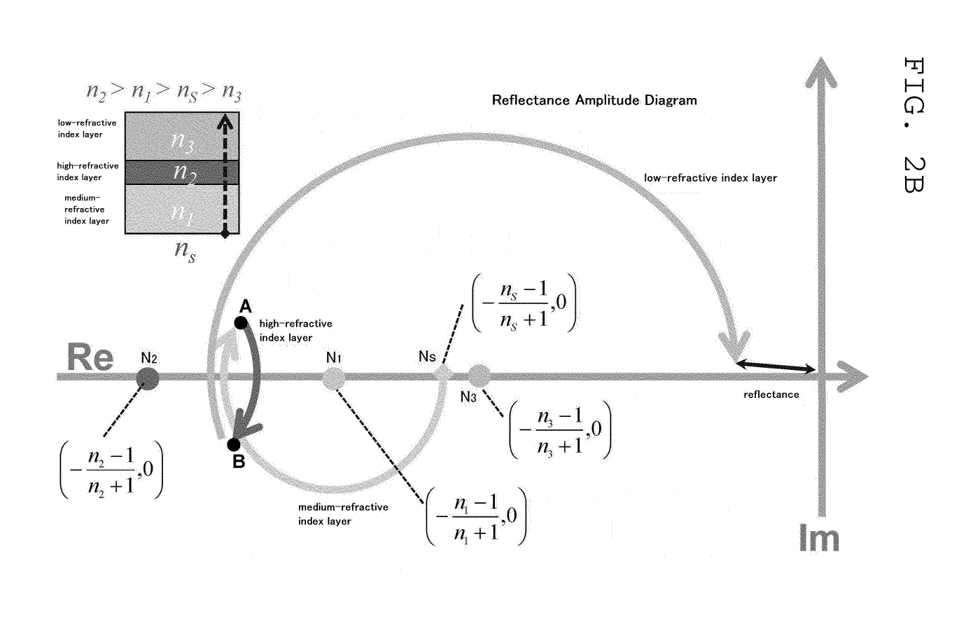

In the present invention, when the optical design of a reflection characteristic of the anti-reflection film is performed with the complex plane of a reflectance amplitude diagram at a wavelength of 580 nm, the refractive indices and/or thicknesses of the substrate 10, the medium-refractive index layer 20, the high-refractive index layer 40, and the low-refractive index layer 50 are designed in such a manner that a line AB connecting a starting point A and an ending point B of the lamination locus of the high-refractive index layer intersects the real axis of the reflectance amplitude diagram. Detailed description is given below. The optical design of a wide-spectrum anti-reflection film can be performed with such a complex plane called a reflectance amplitude diagram as illustrated in FIG. 2A or FIG. 2B. For example, the lamination locus and reflectance of a laminate having such a relationship among refractive indices as illustrated in FIG. 2A or FIG. 2B are determined as described below. (1) First, a point corresponding to a reflectance {−(n−1)/(n+1), 0} as a value intrinsic to the refractive index (n) of each layer is spotted in the minus direction of the axis of abscissa (Re: real axis). Specifically, four points, i.e., a point N_{S}{−(n_{S}−1)/(n_{S}+1), 0} of a substrate layer, a point N₁{−(n₁−1)/(n₁+1), 0} of a first layer (the medium-refractive index layer in the present invention), a point N₂{−(n₂−1)/(n₂+1), 0} of a second layer (the high-refractive index layer in the present invention), and a point N₃{−(n₃−1)/(n₃+1), 0} of a third layer (the low-refractive index layer in the present invention) are plotted. (2) A circle is drawn clockwise by using the point N_{S} of the refractive index of the substrate layer as a starting point and the point N₁ of the refractive index of the first layer as a pivot. At this time, the size of an arc (the angle of the arc) corresponds to a thickness and an optical thickness of λ/4 corresponds to a semicircle. (3) Next, a circle is drawn clockwise by using the ending point of the first layer as a starting point and the point N₂ of the refractive index of the second layer as a pivot. (4) Similarly, a circle is drawn clockwise by using the end of the second layer as a starting point and the point N₃ of the refractive index of the third layer as a pivot. (5) A distance between the final point and coordinates (0, 0) corresponds to the reflectance. As the distance becomes shorter, an anti-reflection film having a more excellent reflection characteristic (lower reflectivity) is obtained. Strictly speaking, the “pivot” in such design procedure is not the center of a circle, but for convenience, it is acceptable to perform the design by plotting points that can be easily calculated from the respective refractive indices (such as N_{S}, N₁, N₂, and N₃). Here, the lamination locus is obtained by plotting, on the complex plane, amplitude reflectances calculated for respective positions in a direction from the substrate of the laminate toward an air interface, and means a reflectance at each of the positions. Therefore, a change in reflectance at each position when, for example, a laminate illustrated at the upper left of FIG. 2A or FIG. 2B is moved as indicated by the arrow is the lamination locus. The lamination locus progresses to a larger extent as the wavelength of light becomes shorter, and progresses to a smaller extent as the wavelength of the light becomes longer. Accordingly, as the wavelength varies, the lamination locus changes and hence the final reflectance also varies. Therefore, a key factor in a wide-spectrum low-reflection design is to bring the final reflectance into a state close to (0, 0) in as wide a wavelength region as possible around a design wavelength of 580 nm. It should be noted that a reflectance that can be actually measured is the square of a distance from (0, 0), but in the design, there is no harm in regarding the distance as the reflectance in a conceptual sense. In the present invention, as described above, the refractive indices and/or thicknesses of the substrate, the medium-refractive index layer, the high-refractive index layer, and the low-refractive index layer are designed in such a manner that the line AB connecting the starting point A and ending point B of the lamination locus of the high-refractive index layer intersects the real axis of the reflectance amplitude diagram. That is, in FIG. 2A or FIG. 2B, the following optical design is performed: the line AB connecting the ending point A of the first layer (the medium-refractive index layer) (i.e., the starting point of the second layer (the high-refractive index layer)) and the ending point B of the high-refractive index layer intersects the real axis of the reflectance amplitude diagram. When such optical design that the line AB intersects the real axis of the reflectance amplitude diagram is performed while the distance between the final point and coordinates (0, 0) is kept small, an anti-reflection film, which not only realizes an excellent reflection characteristic but also prevents the coloring of the reflection hue of incident light in each of a front direction and an oblique direction, can be obtained. More specifically, when the symmetry of the lamination locus of the high-refractive index layer with respect to the real axis at a design wavelength of 580 nm is high, the same locus is easily achieved in the entire wavelength region near 580 nm and hence the reflectance can be kept low. As a result, the reflectance becomes low in a wide wavelength region and hence a neutral hue is easily maintained for the reflection hue of the incident light in the oblique direction. Further, such optical design is comprehensive, and hence eliminates the need to investigate the thicknesses and/or refractive indices of the respective layers of each product through trial and error. That is, in substantially all combinations of wide-spectrum anti-reflection films each having a construction “substrate/medium-refractive index layer/high-refractive index layer/low-refractive index layer,” the use of the optical design can realize an anti-reflection film having an excellent reflection characteristic and an excellent reflection hue. As a result, the optimization of the reflection characteristic and the reflection hue can be performed in an extremely general and easy manner. In addition, when the design is performed in such a manner that the ending point A of the lamination locus of the medium-refractive index layer is positioned above the real axis as illustrated in FIG. 2B, the thickness of the high-refractive index layer can be made extremely small. It should be noted that in the description of the anti-reflection film of the present invention, the refractive indices of the medium-refractive index layer, the high-refractive index layer, and the low-refractive index layer are represented by n_{M}, n_{H}, and n_{L}, respectively unlike notations in the general description of FIG. 2A or FIG. 2B. In addition, the refractive index n_{S} of the substrate, the refractive index n_{M} of the medium-refractive index layer, and the refractive index n_{H} of the high-refractive index layer have a relationship of n_{H}>n_{M}>n_{S}.

The anti-reflection film having a construction “substrate/medium-refractive index layer/high-refractive index layer/low-refractive index layer” (the embodiment of FIG. 1A) has been described above. However, the same optical design can be performed for the anti-reflection film having a construction “substrate/another high-refractive index layer/another low-refractive index layer/high-refractive index layer/low-refractive index layer” (the embodiment of FIG. 1B). Specifically, the ending point of the lamination locus of the other low-refractive index layer only needs to be defined as the starting point A of the line AB.

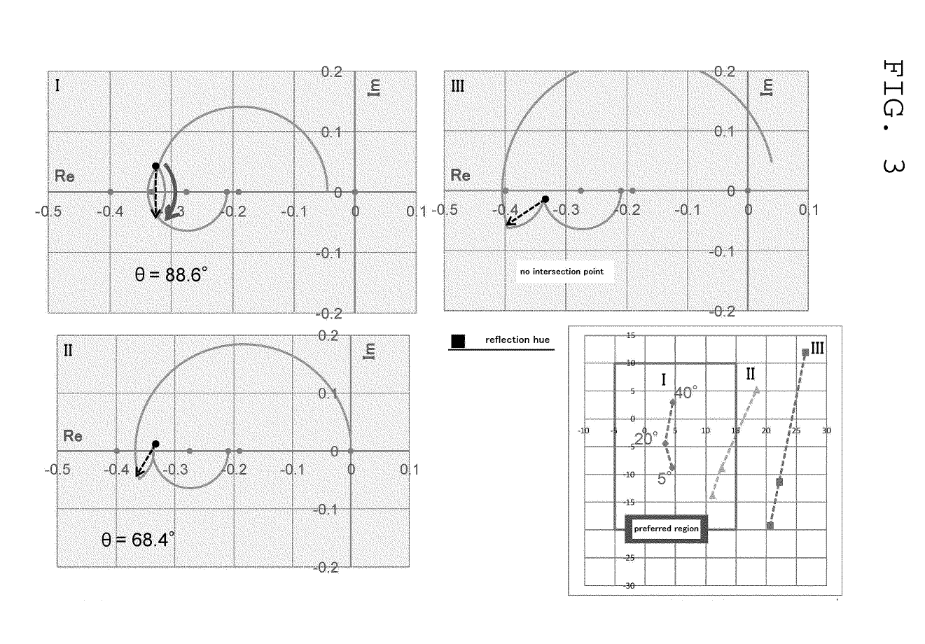

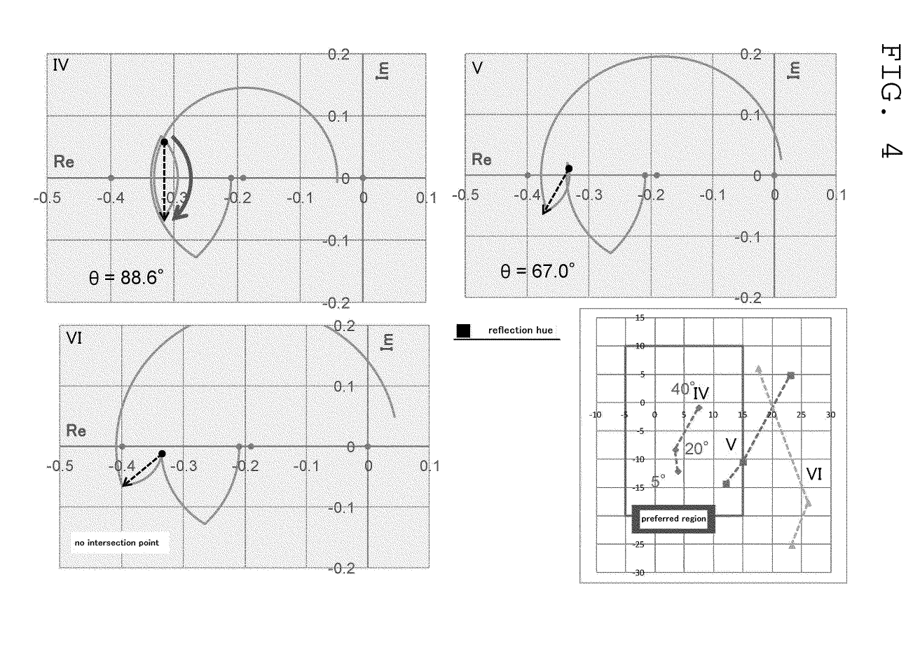

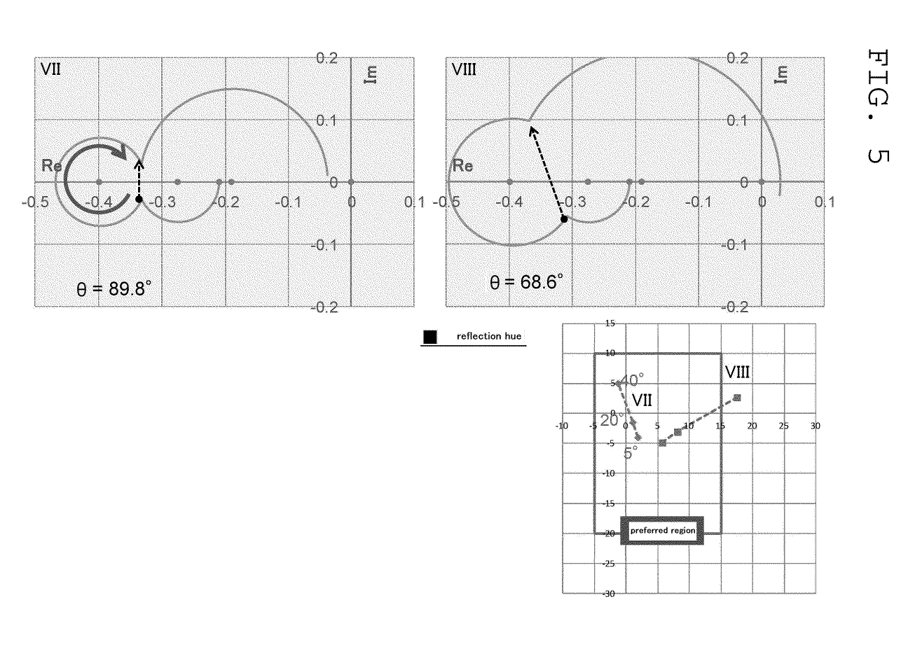

In one embodiment, the refractive indices and/or thicknesses of the substrate 10, the medium-refractive index layer 20, the high-refractive index layer 40, and the low-refractive index layer 50 are designed in such a manner that the line AB and the real axis intersect each other, and an angle θ formed between the line AB and the real axis preferably satisfies a relationship of 65°≦θ≦90°. The angle θ is more preferably from 70° to 90°, still more preferably from 75° to 90°. Setting the angle θ within such range can provide an anti-reflection film having an additionally excellent reflection hue. As in the foregoing, the optical design can realize comprehensive and general optimization of a reflection characteristic and a reflection hue. Specific description is given with reference to an actual optical design. Each of FIG. 3 to FIG. 5 is an illustration of a relationship between an optical design in which the angle θ is changed and a reflection hue for incident light from an oblique direction actually obtained by the design. Further, a relationship between an optical design in which the line AB does not intersect the real axis and a reflection hue for incident light from an oblique direction actually obtained by the design is illustrated in each of FIG. 3 and FIG. 4 together. In FIG. 3, an anti-reflection film designed at an angle θ of 88.6° (Optical Design I) provides a neutral and excellent reflection hue in each of the cases where angles of incidence are 5°, 20°, and 40°. An anti-reflection film designed at an angle θ of 68.4° (Optical Design II) provides a neutral and excellent reflection hue in the case where the angle of incidence is 5° or 20°, but causes undesired coloring in the case where the angle of incidence is 40°. An anti-reflection film of a design in which the line AB does not intersect the real axis (Optical Design III) is observed to cause remarkable coloring at each of the angles of incidence. The same tendency is clearly illustrated in each of FIG. 4 and FIG. 5 as well. It should be noted that the angle θ means an acute angle out of the angles formed between the line AB and the real axis. In addition, as described with reference to FIG. 2B, when the design is performed in such a manner that the ending point of the lamination locus of the medium-refractive index layer is positioned above the real axis like each of Optical Designs I and IV, the thickness of the high-refractive index layer can be made extremely small.

In one embodiment, when the optical design of the reflection characteristic of the anti-reflection film is performed with the complex plane of the reflectance amplitude diagram, the refractive indices and/or thicknesses of the substrate 10, the medium-refractive index layer 20, the high-refractive index layer 40, and the low-refractive index layer 50 are designed in such a manner that the line AB and the real axis intersect each other in each of optical designs over the wavelength range of from 550 nm to 700 nm. The lamination locus of the complex plane varies from wavelength to wavelength in a visible light region, but the optical design is generally performed at a wavelength of 580 nm at which luminous sensitivity is said to be highest. As in the case where the design is performed at 580 nm by using the intersection angle between the line AB and the real axis as an indicator as described above, an anti-reflection film having excellent reflection characteristics at respective wavelengths can also be obtained by performing an optical design in such a manner that the line AB and the real axis intersect each other in each of the lamination loci at the respective wavelengths. Therefore, an anti-reflection film having an excellent reflection characteristic in a wide wavelength region can be obtained by performing such an optical design that the line AB and the real axis intersect each other over the wavelength range of from 550 nm to 700 nm. The optical design is also comprehensive and general as in the foregoing. Accordingly, the design eliminates the need to investigate the thicknesses and/or refractive indices of the respective layers of each product through trial and error, and is of extreme technological significance.

It should be noted that in the embodiment in which the medium-refractive index layer 20 is a single layer (the embodiment of FIG. 1A), the thickness of the high-refractive index layer can be markedly reduced as compared to a conventional one by performing the optical design through the use of the complex plane of the reflectance amplitude diagram. For example, the thickness of the high-refractive index layer can be set to 50 nm or less. The high-refractive index layer is typically formed by the sputtering of a metal oxide such as Nb₂O₅, but the rate of such sputtering is known to be extremely slow. Therefore, the production efficiency of the entirety of the anti-reflection film can be significantly improved by reducing the thickness of the high-refractive index layer.

The reflection hue of the vertical incidence of the anti-reflection film in the CIE-Lab colorimetric system is as follows: relationships of 0≦a*≦15 and −20≦b*≦0 are preferably satisfied, and relationships of 0≦a*≦10 and −15≦b*≦0 are more preferably satisfied. According to the present invention, the optimization of the refractive indices and/or thicknesses of the respective layers using the above-mentioned optical design can provide an anti-reflection film having an excellent reflection hue that is close to neutral. It should be noted that the term “vertical incidence” as used herein means 5° regular reflection in terms of measurement. The vertical incidence and the 5° regular reflection can be treated as being substantially the same.

The luminous reflectance Y of the anti-reflection film is preferably as low as possible, and is preferably 1.0% or less, more preferably 0.7% or less, still more preferably 0.5% or less. As described above, according to the present invention, compatibility between a low luminous reflectance (an excellent anti-reflection characteristic) and a reflection hue that colors to a small extent and is close to neutral (an excellent reflection hue) can be achieved in a multilayer anti-reflection film.

Hereinafter, each layer constituting the anti-reflection film is described in detail.

A-1. Substrate

The substrate 10 can be constituted of any appropriate resin film as long as the effects of the present invention are obtained. Specifically, the substrate 10 can be a resin film having transparency. Specific examples of the resin for forming the film include polyolefin-based resins (such as polyethylene and polypropylene), polyester-based resins (such as polyethylene terephthalate and polyethylene naphthalate), polyamide-based resins (such as nylon-6 and nylon-66), a polystyrene resin, a polyvinyl chloride resin, a polyimide resin, a polyvinyl alcohol resin, an ethylene vinyl alcohol resin, a (meth)acrylic resin, a (meth)acrylonitrile resin, and cellulose-based resins (such as triacetylcellulose, diacetylcellulose, and cellophane). The substrate may be a single layer, may be a laminate of a plurality of resin films, or may be a laminate of a resin film (a single layer or a laminate) and the following hard coat layer. The substrate (substantially a composition for forming the substrate) can contain any appropriate additive. Specific examples of the additive include an antistatic agent, a UV-absorbing agent, a plasticizer, a lubricant, a colorant, an antioxidant, and a flame retardant. It should be noted that detailed description of a material constituting the substrate is omitted because the material is well known in the art.

In one embodiment, the substrate 10 can function as a hard coat layer. That is, as described above, the substrate 10 may be a laminate of a resin film (a single layer or a laminate) and a hard coat layer to be described below. Alternatively, the hard coat layer may constitute the substrate alone. When the substrate is constituted of the laminate of the resin film and the hard coat layer, the hard coat layer can be placed so as to be adjacent to the medium-refractive index layer 20. The hard coat layer is a cured layer of any appropriate ionizing radiation-curable resin. Examples of an ionizing radiation include UV light, visible light, an infrared ray, and an electron beam. Of those, UV light is preferred. Therefore, the ionizing radiation-curable resin is preferably a UV-curable resin. Examples of the UV-curable resin include a (meth)acrylic resin, a silicone-based resin, a polyester-based resin, a urethane-based resin, an amide-based resin, and an epoxy-based resin. A typical example of the (meth)acrylic resin is a cured product (polymerized product) obtained by curing a (meth)acryloyloxy group-containing polyfunctional monomer with a UV light. The polyfunctional monomers may be used alone or in combination. Any appropriate photopolymerization initiator can be added to the polyfunctional monomer. It should be noted that detailed description of a material constituting the hard coat layer is omitted because the material is well known in the art.

Any appropriate inorganic or organic fine particles can be dispersed in the hard coat layer. The particle diameter of each of the fine particles is, for example, from 0.01 μm to 3 μm. Alternatively, an uneven shape can be formed on the surface of the hard coat layer. The adoption of such construction can impart a light-diffusing function generally referred to as “antiglare”. Silicon oxide (SiO₂) can be suitably used as the fine particles to be dispersed in the hard coat layer from the viewpoints of, for example, a refractive index, stability, and heat resistance. Further, the hard coat layer (substantially a composition for forming the hard coat layer) can contain any appropriate additive. Specific examples of the additive include a leveling agent, a filler, a dispersant, a plasticizer, a UV-absorbing agent, a surfactant, an antioxidant, and a thixotropic agent.

The hard coat layer has a hardness of preferably H or more, more preferably 3H or more in a pencil hardness test. The measurement of the pencil hardness test may be performed in conformity with JIS K 5400.

The thickness of the substrate 10 can be appropriately set depending on, for example, a purpose and the construction of the substrate. When the substrate is constituted as a single layer of a resin film or a laminate of resin films, the thickness is, for example, from 10 μm to 200 μm. When the substrate includes a hard coat layer or when the substrate is constituted of the hard coat layer alone, the thickness of the hard coat layer is, for example, from 1 μm to 50 μm.

The refractive index of the substrate 10 (when the substrate has a laminated structure, the refractive index of a layer adjacent to the medium-refractive index layer) is preferably from 1.45 to 1.65, more preferably from 1.50 to 1.60. Such refractive index can increase a degree of freedom in design of the medium-refractive index layer for satisfying the optical design as described above. It should be noted that the term “refractive index” as used herein refers to a refractive index measured at a temperature of 25° C. and a wavelength A of 580 nm on the basis of JIS K 7105 unless otherwise stated.

A-2. Medium-Refractive Index Layer

### A-2-1. Medium-Refractive Index Layer as a Single Layer

In one embodiment, the medium-refractive index layer 20 may be, for example, a single layer as shown in FIG. 1A. In such an embodiment, the medium-refractive index layer 20 typically contains a binder resin and inorganic fine particles dispersed in the binder resin. The binder resin is typically an ionizing radiation-curable resin, more specifically a UV-curable resin. Examples of the UV-curable resin include radical-polymerizable monomers and oligomers such as a (meth)acrylate resin (epoxy (meth)acrylate, polyester (meth)acrylate, acrylic (meth)acrylate, or ether (meth)acrylate). A monomer component (precursor) that constructs the acrylate resin preferably has a molecular weight of from 200 to 700. Specific examples of the monomer component (precursor) that constructs the (meth)acrylate resin include pentaerythritol triacrylate (PETA, molecular weight: 298), neopentylglycol diacrylate (NPGDA, molecular weight: 212), dipentaerythritol hexaacrylate (DPHA, molecular weight: 632), dipentaerythritol pentaacrylate (DPPA, molecular weight: 578), and trimethylolpropane triacrylate (TMPTA, molecular weight: 296). If required, an initiator may be added. Examples of the initiator include a UV radical generator (e.g., Irgacure 907, 127, or 192 manufactured by Ciba Specialty Chemicals) and benzoyl peroxide. The binder resin may contain another resin component other than the above-mentioned ionizing radiation-curable resin. The another resin component may be an ionizing radiation-curable resin, a thermosetting resin, or a thermoplastic resin. Typical examples of the another resin component include an aliphatic (for example, polyolefin) resin and a urethane-based resin. In the case of using the another resin component, the kind and blending amount thereof are adjusted so that the refractive index of the medium-refractive index layer to be obtained satisfies the optical design as described above.

The refractive index of the binder resin is preferably from 1.40 to 1.60.

The blending amount of the binder resin is preferably from 10 parts by weight to 80 parts by weight, more preferably from 20 parts by weight to 70 parts by weight with respect to 100 parts by weight of the medium-refractive index layer to be formed.

The inorganic fine particles may be constituted of, for example, a metal oxide. Specific examples of the metal oxide include zirconium oxide (zirconia) (refractive index: 2.19), aluminum oxide (refractive index: 1.56 to 2.62), titanium oxide (refractive index: 2.49 to 2.74), and silicon oxide (refractive index: 1.25 to 1.46). Each of those metal oxides absorbs a small quantity of light and has a refractive index that is hardly expressed by an organic compound such as an ionizing radiation-curable resin or a thermoplastic resin. Accordingly, the refractive index of the medium-refractive index layer can be easily adjusted, and as a result, a medium-refractive index layer having such a refractive index as to satisfy the optical design as described above can be formed by coating. Particularly preferred inorganic compounds are zirconium oxide and titanium oxide. This is because each of zirconium oxide and titanium oxide has an appropriate refractive index and appropriate dispersibility in the binder resin, and hence can form a medium-refractive index layer having a desired refractive index and a desired dispersed structure.

The refractive index of the inorganic fine particles is preferably 1.60 or more, more preferably from 1.70 to 2.80, particularly preferably from 2.00 to 2.80. When the refractive index falls within such range, a medium-refractive index layer having a desired refractive index can be formed.

The average particle diameter of the inorganic fine particles is preferably from 1 nm to 100 nm, more preferably from 10 nm to 80 nm, still more preferably from 20 nm to 70 nm. As described above, by using the inorganic fine particles with an average particle diameter smaller than the wavelength of light, geometric reflection, refraction, and scattering are not caused between the inorganic fine particles and the binder resin, and a medium-refractive index layer that is optically uniform can be obtained.

It is preferred that the inorganic fine particles has satisfactory dispersibility with the binder resin. The term “satisfactory dispersibility” as used herein means that a coating film, which is obtained by applying an application liquid obtained by mixing the binder resin, the inorganic fine particles (if required, a small amount of a UV initiator), and a volatile solvent, followed by removing the solvent by drying, is transparent.

In one embodiment, the inorganic fine particles are subjected to surface modification. By conducting surface modification, the inorganic fine particles can be dispersed satisfactorily in the binder resin. As surface modification means, any suitable means can be adopted as long as the effect of the present invention is obtained. Typically, the surface modification is conducted by applying a surface modifier onto the surface of each of the inorganic fine particles to form a surface modifier layer. Specific examples of the preferred surface modifier include coupling agents such as a silane-based coupling agent and a titanate-based coupling agent, and a surfactant such as a fatty acid-based surfactant. By using such surface modifier, the wettability between the binder resin and the inorganic fine particles can be enhanced, the interface between the binder resin and the inorganic fine particles can be stabilized, and the inorganic fine particles can be dispersed satisfactorily in the binder resin. In another embodiment, the inorganic fine particles can be used without being subjected to any surface modification.

The blending amount of the inorganic fine particles is preferably from 10 parts by weight to 90 parts by weight, more preferably from 20 parts by weight to 80 parts by weight with respect to 100 parts by weight of the medium-refractive index layer to be formed. When the blending amount of the inorganic fine particles is excessively large, the mechanical characteristics of an anti-reflection film to be obtained become insufficient in some cases. In addition, in terms of optical design, the thickness of the high-refractive index layer needs to be increased and hence the productivity of the anti-reflection film becomes insufficient in many cases. When the blending amount is excessively small, a desired luminous reflectance is not obtained in some cases.

The thickness of the medium-refractive index layer 20 is preferably from 40 nm to 140 nm, more preferably from 50 nm to 120 nm. Such thickness can realize a desired optical thickness.

The refractive index of the medium-refractive index layer 20 is preferably from 1.67 to 1.78, more preferably from 1.70 to 1.78. When an attempt is made to realize low reflectivity in a wide spectrum in a conventional anti-reflection film, in the case where the refractive index of the low-refractive index layer is 1.47 and the refractive index of the high-refractive index layer is 2.33, the refractive index of the medium-refractive index layer has needed to be set to around 1.9. However, according to the present invention, even such low refractive index can realize desired optical characteristics. As a result, the medium-refractive index layer can be formed by the application and curing of a resin-based composition whose refractive index cannot be increased to a very large extent from the viewpoint of a mechanical characteristic (hardness), which can largely contribute to an improvement in productivity and a cost reduction.

A-2-2. Medium-Refractive Index Layer Having Laminated Structure

In another embodiment, the medium-refractive index layer has a laminated structure in which the other high-refractive index layer 21 and the other low-refractive index layer 22 are arranged in the stated order from the substrate 10 side as illustrated in, for example, FIG. 1B. The thicknesses and/or refractive indices of the other high-refractive index layer and the other low-refractive index layer can be set in such a manner that the position of the ending point of the other low-refractive index layer that has passed the other high-refractive index layer in the reflectance amplitude diagram is the same as that of the ending point of the lamination locus of the medium-refractive index layer as described above. With regard to, for example, a specific constituent material for the other high-refractive index layer, reference can be made to the description of the high-refractive index layer 40 in a section A-4 to be described later. With regard to, for example, a specific constituent material for the other low-refractive index layer, reference can be made to the description of the low-refractive index layer 50 in a section A-5 to be described later. A laminated structure optically equivalent to the medium-refractive index layer can be realized by, for example, designing the optical thickness of each of the other high-refractive index layer and the other low-refractive index layer to about λ/8. It should be noted that the optical thickness is the product of a refractive index and a thickness, and is represented as a ratio with respect to a wavelength of interest (in this case, 580 nm).

A-3. Adhesion Layer

The adhesion layer 30 is any appropriate layer that may be arranged for improving adhesiveness between adjacent layers (the medium-refractive index layer 20 and the high-refractive index layer 40 in the embodiment of FIG. 1A). The adhesion layer can be constituted of, for example, silicon. The thickness of the adhesion layer is, for example, from 2 nm to 5 nm. It should be noted that as described above, the position at which the adhesion layer is formed is not limited to the illustrated example as long as the layer improves the adhesiveness between the adjacent layers.

A-4. High-Refractive Index Layer

When the high-refractive index layer 40 is used in combination with the low-refractive index layer 50, the anti-reflection film can efficiently prevent the reflection of light by virtue of a difference between their respective refractive indices. The high-refractive index layer 40 can be preferably placed so as to be adjacent to the low-refractive index layer 50. Further, the high-refractive index layer 40 can be preferably placed on the substrate side of the low-refractive index layer 50. Such construction can prevent the reflection of light in an extremely efficient manner.

In one embodiment (e.g., each of Optical Design I of FIG. 3 and Optical Design IV of FIG. 4), the thickness of the high-refractive index layer 40 is preferably from 10 nm to 50 nm, and in another embodiment (e.g., Optical Design VII of FIG. 5), the thickness is preferably from 70 nm to 120 nm.

The refractive index of the high-refractive index layer 40 is preferably from 2.00 to 2.60, more preferably from 2.10 to 2.45. With such refractive index, a desired refractive index difference between the high-refractive index layer and the low-refractive index layer can be secured, and hence the reflection of light can be efficiently prevented.

In one embodiment (e.g., each of Optical Design I of FIG. 3 and Optical Design IV of FIG. 4), the optical thickness of the high-refractive index layer 40 at a wavelength of 580 nm is preferably from about λ/32 to λ/4, and in another embodiment (e.g., Optical Design VII of FIG. 5), the optical thickness is preferably from about λ/4 to λ/2.

Any appropriate material can be used as a material constituting the high-refractive index layer 40 as long as the desired characteristics are obtained. Typical examples of such material include a metal oxide and a metal nitride. Specific examples of the metal oxide include titanium oxide (TiO₂), indium/tin oxide (ITO), niobium oxide (Nb₂O₅), yttrium oxide (Y₂O₂), indium oxide (In₂O₃), tin oxide (SnO₂), zirconium oxide (ZrO₂), hafnium oxide (HfO₂), antimony oxide (Sb₂O₂), tantalum oxide (Ta₂O₅), zinc oxide (ZnO), and tungsten oxide (WO₂). A specific example of the metal nitride is silicon nitride (Si₂N₄). Of those, niobium oxide (Nb₂O₅) or titanium oxide (TiO₂) is preferred. This is because Nb₂O₅ or TiO₂ has an appropriate refractive index and a low sputtering rate, and thus, the thinner film formation effect of the present invention becomes significant.

A-5. Low-Refractive Index Layer

As described above, when the low-refractive index layer 50 is used in combination with the high-refractive index layer 40, the anti-reflection film can efficiently prevent the reflection of light by virtue of the difference between their respective refractive indices. The low-refractive index layer 50 can be preferably placed so as to be adjacent to the high-refractive index layer 40. Further, the low-refractive index layer 50 can be preferably placed on the side of the high-refractive index layer 40 opposite to the substrate. Such construction can prevent the reflection of light in an extremely efficient manner.

The thickness of the low-refractive index layer 50 is preferably from 70 nm to 120 nm, more preferably from 80 nm to 115 nm. Such thickness can realize a desired optical thickness.

The refractive index of the low-refractive index layer 50 is preferably from 1.35 to 1.55, more preferably from 1.40 to 1.50. With such refractive index, a desired refractive index difference between the low-refractive index layer and the high-refractive index layer can be secured, and hence the reflection of light can be efficiently prevented.

The optical thickness of the low-refractive index layer 50 at a wavelength of 580 nm is about λ/4 because the layer corresponds to a general low-reflection layer.

Any appropriate material can be used as a material constituting the low-refractive index layer 50 as long as the desired characteristics are obtained. Typical examples of such material include a metal oxide and a metal fluoride. A specific example of the metal oxide is silicon oxide (SiO₂). Specific examples of the metal fluoride include magnesium fluoride and silicon oxide fluoride. Magnesium fluoride or silicon oxide fluoride is preferred from the viewpoint of its refractive index, silicon oxide is preferred from the viewpoints of ease of production, mechanical strength, moisture resistance, and the like, and silicon oxide is preferred in total consideration of various characteristics.

B. Method of Producing Anti-Reflection Film

Hereinafter, an example of a method of producing an anti-reflection film of the present invention is described.

B-1. Preparation of Substrate

First, the substrate 10 is prepared. A resin film formed of a composition containing such resin as described in the section A-1 may be used as the substrate 10, or a commercially available resin film may be used. Any appropriate method can be adopted as a method of forming the resin film. Specific examples thereof include extrusion and a solution casting method. When a laminate of resin films is used as the substrate, the substrate can be formed by, for example, co-extrusion.

When the substrate includes a hard coat layer, the hard coat layer is formed on, for example, the resin film. Any appropriate method can be adopted as a method of forming the hard coat layer on the substrate. Specific examples thereof include: application methods such as roll coating, die coating, air knife coating, blade coating, spin coating, reverse coating, and gravure coating; and printing methods such as gravure printing, screen printing, offset printing, and ink jet printing. When the substrate is constituted of the hard coat layer alone, it is appropriate to peel the resin film from the formed laminate of the resin film/the hard coat layer.

B-2. Formation of Medium-Refractive Index Layer

Next, the medium-refractive index layer 20 is formed on the substrate 10 prepared as described in the section B-1. In one embodiment, a composition for forming a medium-refractive index layer containing such binder resin and inorganic fine particles as described in the section A-2-1 (application liquid) is applied onto the substrate. A solvent can be used for improving the applicability of the application liquid. Any appropriate solvent in which the binder resin and the inorganic fine particles can be satisfactorily dispersed can be used as the solvent. Any appropriate method can be adopted as a method for the application. Specific examples of the application method include such methods as described in the section B-1. Next, the applied composition for forming a medium-refractive index layer is cured. When such binder resin as described in the section A-2-1 is used, the curing is performed by irradiation with an ionizing radiation. When UV light is used as the ionizing radiation, its cumulative light quantity is preferably from 200 mJ to 400 mJ. A heat treatment may be performed before and/or after the irradiation with the ionizing radiation as required. A heating temperature and a heating time can be appropriately set depending on a purpose and the like. As described above, in one embodiment of the production method of the present invention, the medium-refractive index layer 20 is formed by the wet process (application and curing). In other embodiment of the production method of the present invention, the medium-refractive index layer 20 is formed as a laminate structure of other high-refractive index layer and other ow-refractive index layer as described in the section B-4 and B-5.

B-3. Formation of Adhesion Layer

Next, the adhesion layer 30 is formed on the medium-refractive index layer 20 formed as described in the section B-2 as required. The adhesion layer 30 is typically formed by a dry process. Specific examples of the dry process include a physical vapor deposition (PVD) method and a chemical vapor deposition (CVD)method. Examples of the PVD method include a vacuum deposition method, a reactive deposition method, an ion beam assisted method, a sputtering method, and an ion plating method. An example of the CVD method is a plasma CVD method. Of those, a sputtering method may suitably be used when an in-line treatment is performed. The adhesion layer 30 is formed by, for example, sputtering with silicon. It should be noted that as described above, the adhesion layer is formed as required, and may be omitted. It should also be noted that, when the adhesion layer is formed, the position of the adhesion layer is not limited to the examples by FIGs as long as the adhesion layer increases the adhesion property between adjacent layers.

B-4. Formation of High-Refractive Index Layer

Next, the high-refractive index layer 40 is formed on the medium-refractive index layer 20, or when the adhesion layer 30 is formed, the layer is formed on the adhesion layer. The high-refractive index layer 40 is typically formed by the dry process. In one embodiment, the high-refractive index layer 40 is formed by the sputtering of a metal oxide (such as Nb₂O₅) or a metal nitride. In another embodiment, the high-refractive index layer 40 is formed by sputtering a metal while introducing oxygen to oxidize the metal. In the present invention, thickness control is important because the thickness of the high-refractive index layer is extremely small, but such thickness control can be realized by appropriate sputtering.

B-5. Formation of Low-Refractive Index Layer

Finally, the low-refractive index layer 50 is formed on the high-refractive index layer 40 formed as described in the section B-4. In one embodiment, the low-refractive index layer 50 is formed by the dry process, and is formed by, for example, the sputtering of a metal oxide (such as SiO₂). In another embodiment, the low-refractive index layer 50 is formed by the wet process, and is formed by, for example, the application of a low-refractive index material using polysiloxane as a main component. In addition, the low-refractive index layer may be formed by: performing sputtering until part of a desired thickness is achieved; and then performing application until the remainder is achieved.

An antifouling layer may be arranged as a film that is so thin as not to impair the optical characteristics of the anti-reflection film (from about 1 nm to 10 nm) on the low-refractive index layer as required. The antifouling layer may be formed by the dry process or may be formed by the wet process depending on a formation material therefor.

Thus, the anti-reflection film can be produced.

C. Applications of Anti-Reflection Film

The anti-reflection film of the present invention can be suitably utilized for preventing the reflection of ambient light in an image display apparatus such as a CRT, a liquid crystal display apparatus, or a plasma display panel. The anti-reflection film of the present invention may be used as a single optical member or may be provided as a member integrated with any other optical member. For example, the film may be provided as a polarizing plate with an anti-reflection film by being bonded to a polarizing plate. Such polarizing plate with an anti-reflection film can be suitably used as, for example, a viewer-side polarizing plate of a liquid crystal display apparatus.

### EXAMPLES

The present invention is specifically described below by way of Examples, but the present invention is not limited to Examples. Testing and evaluating methods in Examples are as described below. Moreover, unless otherwise specified, “%” in Examples is a weight-based unit.

<Evaluations for Optical Characteristics>

In order for a back-surface reflectance to be cut off, a measurement sample was produced by bonding an obtained anti-reflection film to a black acrylic plate (manufactured by Mitsubishi Rayon Co., Ltd., thickness: 2.0 mm) through a pressure-sensitive adhesive. Such measurement sample was measured for its reflectance for 5° regular reflection in a visible light region, reflectance for incident light from a 20° direction, and reflectance for incident light from a 40° direction with a spectrophotometer U4100 (manufactured by Hitachi High-Technologies Corporation). A luminous reflectance (Y (%)) and hues a* and b* in the L*a*b* colorimetric system in a two-degree field of view under a C light source were calculated and determined from the spectra of the resultant reflectances.

### Example 1

The optical design of a reflection characteristic of an anti-reflection film having a construction “substrate/medium-refractive index layer/high-refractive index layer/low-refractive index layer” was performed with the complex plane of a reflectance amplitude diagram at a wavelength of 580 nm. At that time, the refractive indices and thicknesses of the substrate, the medium-refractive index layer, the high-refractive index layer, and the low-refractive index layer were set in such a manner that the line AB connecting the starting point A and ending point B of the lamination locus of the high-refractive index layer intersected the real axis of the reflectance amplitude diagram as illustrated in FIG. 2. Specifically, the anti-reflection film was produced by the following procedure.

A triacetylcellulose (TAC) film with a hard coat (refractive index: 1.53) was used as a substrate. Meanwhile, an application liquid (composition for forming a medium-refractive index layer) was prepared by diluting a resin composition (manufactured by JSR Corporation, trade name: “OPSTAR KZ Series”) containing zirconia particles (average particle diameter: 40 nm, refractive index: 2.19) at a content of about 70% with respect to its total solid content with MIBK so that the content of the composition became 3%. The application liquid was applied onto the substrate with a bar coater, and was dried at 60° C. for 1 minute. After that, the dried product was irradiated with UV light having a cumulative light quantity of 300 mJ to form a medium-refractive index layer (refractive index: 1.76, thickness: 104 nm). Next, a high-refractive index layer (refractive index: 2.33, thickness: 19 nm) was formed on the medium-refractive index layer by sputtering Nb₂O₅. Further, a low-refractive index layer (refractive index: 1.47, thickness: 108 nm) was formed on the high-refractive index layer by sputtering SiO₂. Thus, an anti-reflection film was produced. The results are shown in Table 1. It should be noted that an intersection angle between the line AB and the real axis of the reflectance amplitude diagram is also shown in Table 1.

### Examples 2 to 5 and Comparative Examples 1 and 2

Anti-reflection films were produced according to constructions shown in Table 1. The resultant anti-reflection films were subjected to the evaluations for optical characteristics. The results are shown in Table 1.

TABLE 1

| | | | | High- | | | | | | | | | | | | |
|---|---|---|---|---|---|---|---|---|---|---|---|---|---|---|---|---|
| | | Medium- | | refractive | | Low- | | | | | | | | | | |
| | | refractive | | index | | refractive | | | Inter- | 5° | | | 20° | | 40° | |
| | Substrate | index layer | | layer | | index layer | | Inter- | section | regular reflection | | | incidence | | incidence | |
| | nₛ | n_{M} | d_{M} | n_{H} | d_{H} | n_{L} | d_{L} | section | angle | Y | a* | b* | a* | b* | a* | b* |
| Example 1 | 1.53 | 1.76 | 104 | 2.33 | 19 | 1.47 | 108 | Present | 88.61 | 0.30 | 4.42 | −8.77 | 3.28 | −4.44 | 4.52 | 3.00 |
| Example 2 | 1.53 | 1.76 | 87 | 2.33 | 21 | 1.47 | 104 | Present | 68.35 | 0.20 | 11.06 | −13.77 | 12.62 | −8.89 | 18.38 | 5.24 |
| Example 3 | 1.53 | 1.76 | 90 | 2.33 | 19 | 1.47 | 103 | Present | 77.15 | 0.21 | 8.16 | −9.19 | 9.94 | −5.58 | 16.33 | 5.38 |
| Example 4 | 1.53 | 1.76 | 70 | 2.33 | 109 | 1.47 | 90 | Present | 89.78 | 0.14 | 1.86 | −3.96 | 1.06 | −1.46 | −1.27 | 5.03 |
| Example 5 | 1.53 | 1.76 | 55 | 2.33 | 90 | 1.47 | 85 | Present | 68.56 | 0.31 | 5.73 | −4.86 | 8.12 | −3.04 | 17.55 | 2.69 |
| Comparative | 1.53 | 1.76 | 104 | 2.33 | 5 | 1.47 | 88 | Absent | — | 0.77 | 7.48 | −21.42 | 10.92 | −19.84 | 13.79 | −7.08 |
| Example 1 | | | | | | | | | | | | | | | | |
| Comparative | 1.53 | 176 | 76 | 2.33 | 25 | 1.47 | 102 | Absent | — | 0.49 | 20.64 | −19.24 | 22.16 | −11.34 | 26.48 | 11.98 |
| Example 2 | | | | | | | | | | | | | | | | |

### Example 6

The optical design of an anti-reflection film of a form in which a medium-refractive index layer had a laminated structure of another high-refractive index layer and another low-refractive index layer, i.e., an anti-reflection film having a construction “substrate/another high-refractive index layer/another low-refractive index layer/high-refractive index layer/low-refractive index layer” was performed in the same manner as in Example 1. At that time, the refractive indices and thicknesses of the substrate, the other high-refractive index layer, the other low-refractive index layer, the high-refractive index layer, and the low-refractive index layer were set in such a manner that the line AB connecting the starting point A and ending point B of the lamination locus of the high-refractive index layer intersected the real axis of the reflectance amplitude diagram in conformity with FIG. 2. Specifically, the anti-reflection film was produced by the following procedure.

A triacetylcellulose (TAC) film with a hard coat (refractive index: 1.53) was used as a substrate. Next, another high-refractive index layer (refractive index: 2.33, thickness: 14 nm) was formed on the substrate by sputtering Nb₂O₅. Next, another low-refractive index layer (refractive index: 1.47, thickness: 49 nm) was formed on the other high-refractive index layer by sputtering SiO₂. Further, a high-refractive index layer (refractive index: 2.33, thickness: 26 nm) was formed on the other low-refractive index layer by sputtering Nb₂O₅. Finally, a low-refractive index layer (refractive index: 1.47, thickness: 115 nm) was formed on the high-refractive index layer by sputtering SiO₂. Thus, an anti-reflection film was produced. The results are shown in Table 2. It should be noted that an intersection angle between the line AB and the real axis of the reflectance amplitude diagram is also shown in Table 2.

### Examples 7 to 10 and Comparative Example 3

Anti-reflection films were produced according to constructions shown in Tablet. The resultant anti-reflection films were subjected to the evaluations for optical characteristics. The results are shown in Table 2.

It should be noted that in each of Examples and Comparative Examples, the intersection of the line AB and the real axis of the reflectance amplitude diagram, and the intersection angle therebetween were controlled by changing the thicknesses of the medium-refractive index layer (the other high-refractive index layer and other low-refractive index layer in each of Examples 6 to 10 and Comparative Example 3), the high-refractive index layer, and the low-refractive index layer. However, it is apparent from FIG. 2 that the refractive indices of the respective layers may be changed, or a combination of the refractive indices and thicknesses of the respective layers may be changed.

TABLE 2

| | | Another | | Another | | | | | | |
|---|---|---|---|---|---|---|---|---|---|---|
| | | high- | | low- | | | | | | |
| | | re- | | re- | | High- | | Low- | | |
| | | fractive | | fractive | | refractive | | refractive | | |
| | | index | | index | | index | | index | | |
| | Substrate | layer | | layer | | layer | | layer | | |
| | nₛ | n_{H} | d_{H} | n_{L} | d_{L} | n_{H} | d_{H} | n_{L} | d_{L} | Intersection |
| Example 6 | 1.53 | 2.33 | 14 | 1.47 | 49 | 2.33 | 26 | 1.47 | 105 | Present |
| Example 7 | 1.53 | 2.33 | 14 | 1.47 | 38 | 2.33 | 27 | 1.47 | 105 | Present |
| Example 8 | 1.53 | 2.33 | 17 | 1.47 | 48 | 2.33 | 29.5 | 1.47 | 113 | Present |
| Example 9 | 1.53 | 2.33 | 12 | 1.47 | 22 | 2.33 | 92 | 1.47 | 85 | Present |
| Example 10 | 1.53 | 2.33 | 14 | 1.47 | 26 | 2.33 | 106 | 1.47 | 87 | Present |
| Comparative | 1.53 | 2.33 | 14 | 1.47 | 30 | 2.33 | 26 | 1.47 | 102 | Absent |
| Example 3 | | | | | | | | | | |

| | | 5° | | | 20° | | 40° | |
|---|---|---|---|---|---|---|---|---|
| | Intersection | regular reflection | | | incidence | | incidence | |
| | angle | Y | a* | b* | a* | b* | a* | b* |
| Example 6 | 88.48 | 0.31 | 3.88 | −12.03 | 3.44 | −8.24 | 7.41 | −0.80 |
| Example 7 | 67.01 | 0.27 | 12.06 | −14.29 | 14.97 | −10.41 | 23.06 | 4.91 |
| Example 8 | 77.79 | 0.21 | 4.70 | −10.03 | 2.05 | −4.47 | 2.57 | 3.32 |
| Example 9 | 68.65 | 0.24 | 5.50 | −3.38 | 7.08 | −1.19 | 15.53 | 3.02 |
| Example 10 | 89.34 | 0.14 | 4.86 | −7.69 | 2.58 | −3.23 | −2.77 | 5.39 |
| Comparative | — | 0.61 | 23.30 | −25.11 | 26.06 | −17.61 | 17.58 | 6.13 |
| Example 3 | | | | | | | | |

### Example 11

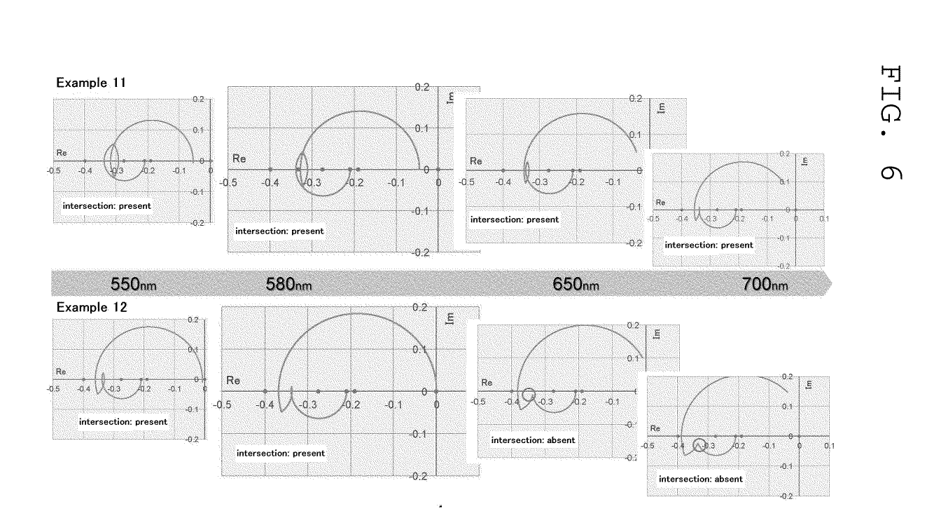

The same optical design as that of Example 1 was performed at 580 nm. Further, optical designs were performed while the design wavelength was changed to 550 nm, 650 nm, and 700 nm. Reflectance amplitude diagrams at the respective design wavelengths are illustrated in FIG. 6 together with the results of Example 12 to be described later.

### Example 12

The same optical design as that of Example 2 was performed at 580 nm. Further, optical designs were performed while the design wavelength was changed to 550 nm, 650 nm, and 700 nm. Reflectance amplitude diagrams at the respective design wavelengths are illustrated in FIG. 6 together with the results of Example 11.

<Evaluation>

As is apparent from Table 1 and Table 2, when the optical design of a reflection characteristic of an anti-reflection film was performed with the complex plane of a reflectance amplitude diagram at a wavelength of 580 nm, the refractive indices and/or thicknesses (in this case, thicknesses) of respective layers were designed in such a manner that the line AB connecting the starting point A and ending point B of the lamination locus of a high-refractive index layer intersected the real axis of the reflectance amplitude diagram. Thus, an anti-reflection film, which not only realized an excellent reflection characteristic but also prevented the coloring of the reflection hue of incident light in each of a front direction and an oblique direction, was able to be obtained. Further, it is found that in each of Examples in which the intersection angle θ between the line AB and the real axis becomes 75° or more, the reflection hue of incident light from an oblique direction can be significantly improved. In addition, as is apparent from comparison between Examples 11 and 12, the optimization of the intersection angle θ at 580 nm secures the intersection of the line AB and the real axis in a wide wavelength region, and hence can provide an anti-reflection film having an excellent reflection characteristic.

### INDUSTRIAL APPLICABILITY

The anti-reflection film of the present invention can be suitably utilized for preventing the reflection of ambient light in an image display apparatus such as a CRT, a liquid crystal display apparatus, or a plasma display panel.

### REFERENCE SIGNS LIST

10 substrate
20 medium-reflective index layer
30 adhesion layer
40 high-reflective index layer
50 low-reflective index layer
100 anti-reflection film

1. An anti-reflection film, comprising:
a substrate; and
a medium-refractive index layer, a high-refractive index layer, and a low-refractive index layer in the stated order from a substrate side,
wherein when optical design of a reflection characteristic of the anti-reflection film is performed with a complex plane of a reflectance amplitude diagram at a wavelength of 580 nm, refractive indices and/or thicknesses of the substrate, the medium-refractive index layer, the high-refractive index layer, and the low-refractive index layer are designed in such a manner that a line AB connecting a starting point A and an ending point B of a lamination locus of the high-refractive index layer intersects a real axis of the reflectance amplitude diagram.

2. The anti-reflection film according to claim 1, wherein the refractive indices and/or thicknesses of the substrate, the medium-refractive index layer, the high-refractive index layer, and the low-refractive index layer are designed in such a manner that the line AB and the real axis intersect each other, and an angle θ formed between the line AB and the real axis satisfies a relationship of 65°≦θ≦90°.

3. The anti-reflection film according to claim 1, wherein when the optical design of the reflection characteristic of the anti-reflection film is performed with the complex plane of the reflectance amplitude diagram, the refractive indices and/or thicknesses of the substrate, the medium-refractive index layer, the high-refractive index layer, and the low-refractive index layer are designed in such a manner that the line AB and the real axis intersect each other in each of optical designs over a wavelength range of from 550 nm to 700 nm.

4. The anti-reflection film according to claim 1, wherein the medium-refractive index layer comprises a single layer.

5. The anti-reflection film according to claim 4, wherein the thickness of the high-refractive index layer is 50 nm or less.

6. The anti-reflection film according to claim 1, wherein the medium-refractive index layer has a laminated structure of another high-refractive index layer and another low-refractive index layer arranged in the stated order from the substrate side.

7. A polarizing plate with an anti-reflection film, comprising the anti-reflection film of claim 1.

8. An image display apparatus, comprising the anti-reflection film of claim 1.

9. An image display apparatus, comprising the polarizing plate with an anti-reflection film of claim 7.
